(19) United States
(12) Patent Application Publication
(10) Pub. No.: US 2013/0240553 A1
(43) Pub. Date: Sep. 19, 2013

(54) Product Dispenser and System with Pivoting Container Support Deck

(71) Applicants: Steven W. Burton, Richmond, VA (US); Bipin Raman Patil, Richmond, VA (US)

(72) Inventors: Steven W. Burton, Richmond, VA (US); Bipin Raman Patil, Richmond, VA (US)

(21) Appl. No.: 13/421,022

(22) Filed: Mar. 15, 2012

(51) Int. Cl. B65G 59/00; B65D 83/00

(52) U.S. Cl. 221/1; 221/285

(57) ABSTRACT

A product dispensing system including a dispenser having a front end longitudinally opposed from a rear end, the dispenser including a container support deck extending at least partially between the front end and the rear end, the container support deck being moveable between a first configuration and a second configuration, and a lower support deck positioned below the container support deck, the lower support deck extending at least partially between the front end and the rear end, and defining a product display area.

### FIELD

This application relates to the dispensing of products from packaging containers and, more particularly, to product dispensers configured to cooperate with packaging containers to dispense products.

### BACKGROUND

Products are typically shipped to retailers in bulk by enclosing multiple individual product units in a container, such as a carton or box. For example, canned foods may be shipped to a retailer in a box containing twenty-four individual cans. Then, it is typically the retailer's obligation to remove the individual product units from the container and present them (e.g., on a shelf) to consumers.

Alternatives to the traditional package-ship-unpack-display model have been developed in an effort to improve operating efficiency. For example, U.S. Pat. No. 7,922,437 (issued on Apr. 12, 2011) discloses a product dispensing system that includes a dispenser having a support structure, a product display area and an opening tool. The dispenser may be positioned on a retailer's shelf and loaded with product simply by placing a container comprising multiple units of product onto the support structure of the dispenser. As the container is being placed onto the support structure, the opening tool of the dispenser opens the container in such a manner that product rolls from the container and down to the product display area of the dispenser under the force of gravity.

Unfortunately, product dispensing systems may experience product bridging that prevents products from properly exiting the container and moving through the dispenser. For example, as shown in FIG. 1, when a container 2 is positioned on a dispenser 4, a product 6A may bridge the gap between the container 2 and product 6B, thereby preventing the products 6 from passing through the opening 8 in the container 2 and moving into the dispenser 4.

Accordingly, those skilled in the art continue with research and development efforts in the field of product dispensers and systems.

### SUMMARY

In one embodiment, the disclosed product dispensing system may include a dispenser having a front end longitudinally opposed from a rear end, the dispenser including a container support deck extending at least partially between the front end and the rear end, the container support deck being moveable between a first configuration and a second configuration, and a lower support deck positioned below the container support deck, the lower support deck extending at least partially between the front end and the rear end, and defining a product display area.

In another embodiment, the disclosed product dispensing system may include a dispenser having a front end longitudinally opposed from a rear end, the dispenser including a container support deck extending at least partially between the front end and the rear end, the container support deck being connected to the dispenser to pivot between a generally horizontal configuration and an angled configuration, and a lower support deck positioned below the container support deck, the lower support deck extending at least partially between the front end and the rear end, and defining a product display area.

In another embodiment, the disclosed product dispensing system may include a dispenser having a front end longitudinally opposed from a rear end, the dispenser including a first side wall laterally opposed from a second side wall, a container support deck pivotally connected to at least one of the side walls and moveable between a first configuration and a second configuration, the container support deck having a front end and a rear end, wherein the front end of the container support deck is generally horizontally aligned with the rear end of the container support deck when the container support deck is in the first configuration, and wherein the front end of the container support deck is elevated relative to the rear end of the container support deck when the container support deck is in the second configuration, and a lower support deck positioned below the container support deck, the lower support deck extending at least partially between the front end of the dispenser and the rear end of the dispenser, and defining a product display area proximate the front end of the dispenser, and a container is positioned on the container support deck.

In yet another embodiment, disclosed is a method for dispensing products. The method may include the steps of (1) providing a dispenser having a front end longitudinally opposed from a rear end, the dispenser including a container support deck extending at least partially between the front and rear ends, wherein the container support deck pivots between a generally horizontal configuration and an angled configuration, and a lower support deck positioned below the container support deck, the lower support deck extending at least partially between the front and rear ends, and defining a product display area, (2) providing a container initially housing a plurality of products, (3) forming an access opening in the container, the access opening being sized and shaped to allow the products to pass therethrough, (4) positioning the container with the access opening on the container support deck and maintaining the container support deck in the horizontal configuration, and (5) after at least one product exits the container through the access opening, moving the container support deck to the angled configuration.

Other embodiments of the disclosed product dispenser, system and method will become apparent from the following detailed description, the accompanying drawings and the appended claims.

### BRIEF DESCRIPTION OF THE DRAWINGS

FIG. 1 is a side elevational view of a prior art product dispensing system, shown with product bridging within the container;

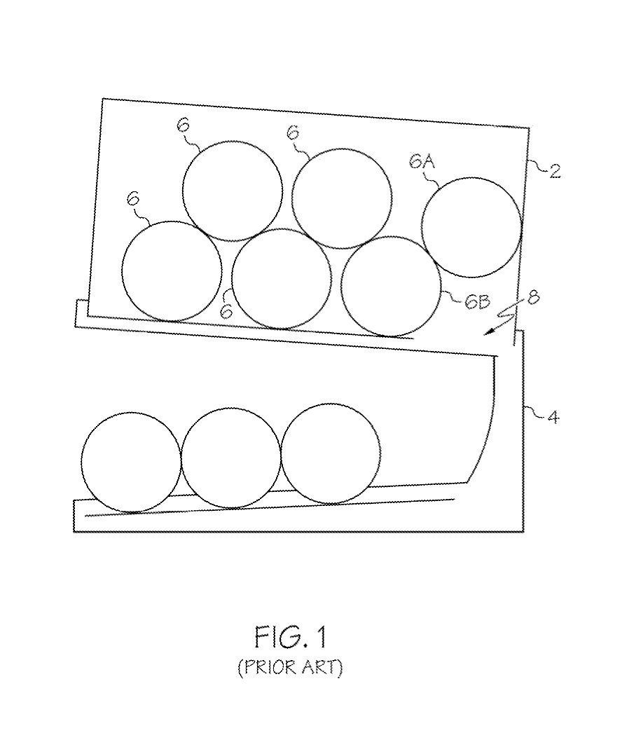

FIG. 2 is a side elevational view of one embodiment of the disclosed product dispensing system with pivoting container support deck;

FIG. 3 is a rear and bottom perspective view of the container of the product dispensing system of FIG. 2;

FIG. 4 is a side elevational view of the dispenser of the product dispensing system of FIG. 2, shown with the container support deck in a generally horizontal configuration;

FIG. 5 is a side elevational view of the dispenser of FIG. 4, shown with the container support deck in an angled, dispensing configuration; and

FIG. 6 is a side elevational view of the product dispensing system of FIG. 2, shown during initial loading of the container onto the dispenser.

### DETAILED DESCRIPTION

It has now been discovered that the occurrence of product bridging in product dispensing systems tends to increase as the angle of the container (relative to horizontal) increases.

Disclosed is a product dispenser and system that employs a pivoting container support deck, wherein the container support deck may pivot between an initial, generally horizontal configuration and a subsequent, angled (e.g., declined) configuration. Without being limited to any particular theory, it is believed that product bridging may be reduced or eliminated by initially maintaining the container in a generally horizontal configuration on the dispenser and then, after a certain number of products have exited the container, moving the container to a non-zero angle relative to horizontal (e.g., a declined angle) to allow gravity to urge the remaining products from the container to the dispenser.

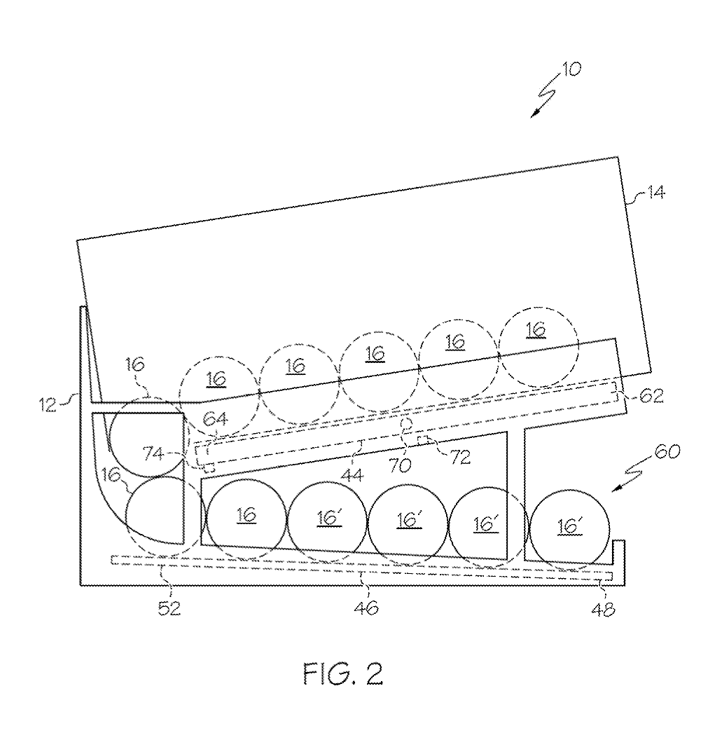

Referring to FIG. 2, one embodiment of the disclosed product dispensing system with pivoting container support deck, generally designated 10, may include a dispenser 12 and a container 14. The container 14 may initially house multiple units of product 16, such as cans (e.g., canned food), jars (e.g., jarred sauce) or bottles (e.g., bottled soft drinks). When the container 14 is loaded onto the dispenser 12, the container 14 may release the products 16 from the container 14 to the dispenser 12.

The container 14 may be any container capable of housing products 16 and beneficially interacting with the disclosed dispenser 12 to release the products 16 to the dispenser 12. For example, the container 14 may be a paperboard carton or a corrugated box. Optionally, at least one major surface of the container 14 may be marked with various indicia, such as printed text and/or graphics.

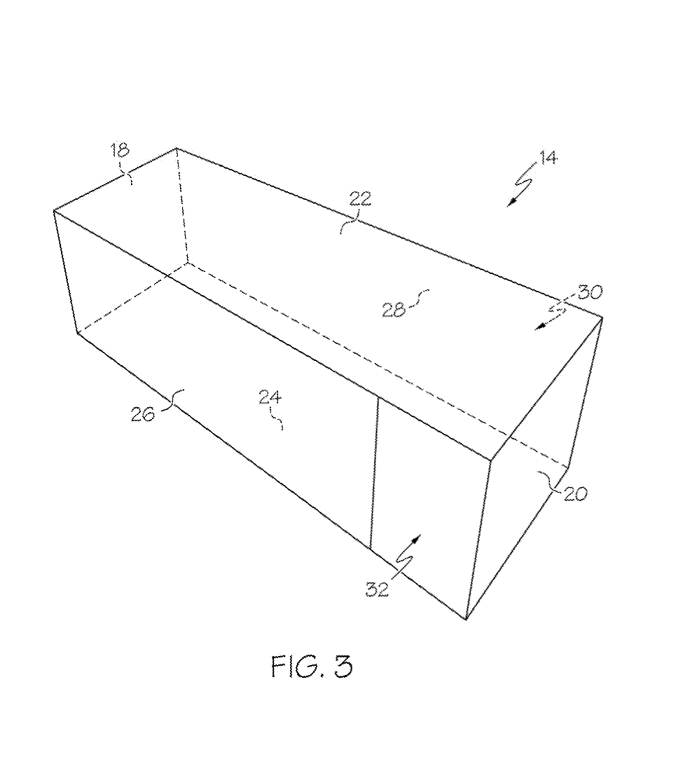

As shown in FIG. 3, the container 14 may be a generally rectilinear container having six walls 18, 20, 22, 24, 26, 28 that define an internal volume 30 for receiving the products 16 (FIG. 2). Opposed walls 18 and 20 may define the front and rear walls, respectively, of the container 14. Opposed walls 22 and 24 may define the first (e.g., right) and second (e.g., left) side walls, respectively, of the container 14. Opposed walls 26 and 28 may define the base and upper walls, respectively, of the container 14. Containers of other shapes and configurations are also contemplated.

The base wall 26 of the container 14 may define an access opening 32. The access opening 32 may be sized and shaped to allow products 16 (FIG. 2) to pass therethrough when the container 14 is mounted on the dispenser 12, as shown in FIG. 2.

The access opening 32 may be positioned proximate the rear wall 20 of the container 14, and may extend generally laterally between the side walls 22, 24 of the container 14. However, those skilled in the art will appreciate that the location of the access opening 32 in the container 14 may depend on, among other things, the configuration of the dispenser 12.

Various techniques, including manual and automatic techniques, may be used to form the access opening 32 in the container 14.

In a first aspect, the access opening 32 may be pre-formed in the base wall 26 of the container 14, as shown in FIG. 3. Optionally, a peelable label or the like (not shown) may be applied to the container 14 over the pre-formed access opening 32. Therefore, the access opening 32 may be revealed by peeling away the optional peelable label from the container 14 prior to loading the container 14 onto the dispenser 12.

In a second aspect, the access opening 32 may be defined by pre-formed weakening features, such as perforations or zipper strips, in the base wall 26 of the container 14. Therefore, the access opening 32 may be formed by tearing a portion (e.g., a generally rectangular panel) of the base wall 26 away from the container 14 along the pre-formed weakening features prior to loading the container 14 onto the dispenser 12.

In a third aspect, the access opening 32 may be automatically formed in the container 14 as the container 14 is urged along the dispenser 12. In a first expression of the third aspect, an opening tool associated with the dispenser 12 may form the access opening 32 as the container 12 is urged along the dispenser 12, as described in U.S. Pat. No. 7,922,437 to Loftin et al., the entire contents of which are incorporated herein by reference. In a second expression of the third aspect, a catch element associated with the dispenser 12 may form the access opening 32 as the container 12 is urged along the dispenser 12, as described in U.S. patent application Ser. No. 13/032,734 filed by Gelardi et al., the entire contents of which are incorporated herein by reference.

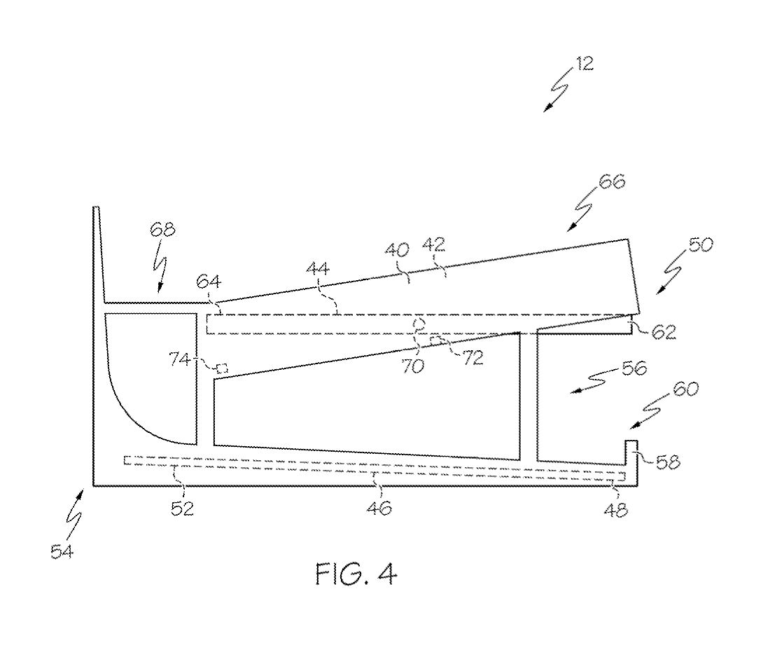

Referring to FIG. 4, the dispenser 12 may include a first (e.g., left) side wall 40, a second (e.g., right) side wall 42, a container support deck 44 and a lower support deck 46. The left side wall 40 may be laterally spaced from the right side wall 42, and may be generally parallel with the right side wall 42.

The lower support deck 46 may laterally extend between the left and right side walls 40, 42, and may include a front end 48 that longitudinally extends toward the front end 50 of the dispenser 12 and a rear end 52 that longitudinally extends toward the rear end 54 of the dispenser 12. Therefore, the lower support deck 46 and the side walls 40, 42 may define a lower level 56 of the dispenser 12.

The lower support deck 46 may be inclined from the front end 48 to the rear end 52 (i.e., the rear end 52 may be elevated relative to the front end 48) such that products 16 deposited proximate the rear end 52 of the lower support deck 46 roll down to the front end 48 of the lower support deck 46 under the force of gravity.

A stop 58 may be positioned proximate the front end 48 of the lower support deck 46 to prevent products 16 from rolling beyond the front end 48 of the lower support deck 46. Therefore, the stop 58 may collect products 16 at the front end 48 of the lower support deck 46, thereby defining a product display area 60 proximate the front end 48 of the lower support deck 46.

The container support deck 44 may laterally extend between the left and right side walls 40, 42, and may include a front end 62 that longitudinally extends toward the front end 50 of the dispenser 12 and a rear end 64 that longitudinally extends toward, but not to, the rear end 54 of the dispenser 12. Therefore, the container support deck 44 and the side walls 40, 42 may define an upper level 66 of the dispenser 12.

The spacing between the rear end 64 of the container support deck 44 and the rear end 54 of the dispenser 12 may define a dispenser opening 68, which may function as a chute to allow products 16 to move from the upper level 66 to the lower level 56 of the dispenser 12. The access opening 32 in the container 14 may be aligned with the dispenser opening 68 of the dispenser 12 when the container 14 is fully loaded onto the dispenser 12.

The container support deck 44 may be connected to the dispenser 12 at a pivot point 70. The pivot point 70 may be positioned between the front end 62 and the rear end 64 of the container support deck 44.

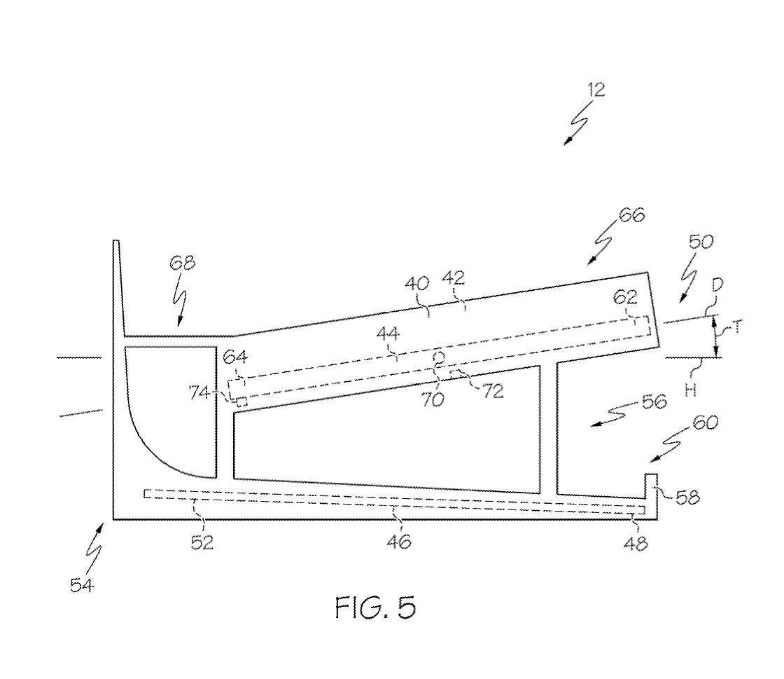

In one specific construction, the container support deck 44 may be connected to the side walls 40, 42 of the dispenser 12 at the pivot point 70. Therefore, the container support deck 44 may pivot relative to the side walls 40, 42 about a pivot axis, which extends into the page in FIG. 4. The pivoting movement of the container support deck 44 may allow the container support deck 44 to move between a horizontal configuration, as shown in FIG. 4, and an angled configuration, as shown in FIG. 5.

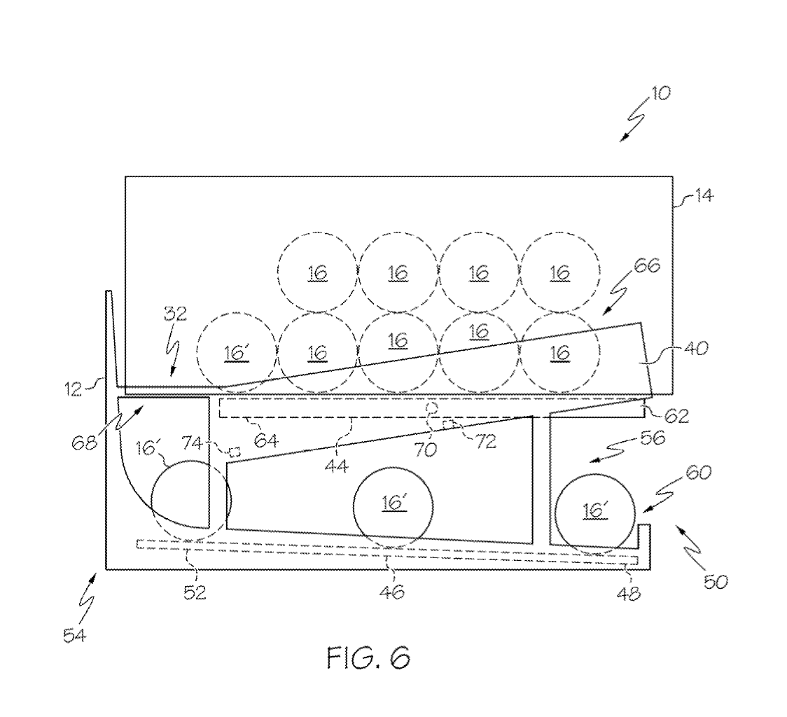

Referring to FIG. 4, in the horizontal configuration, the container support deck 44 may be generally horizontal (i.e., the rear end 64 may be substantially at the same vertical elevation as the front end 116). Therefore, in the horizontal configuration, the force of gravity generally does not urge the products 16 (FIG. 6) supported on the container support deck 44 toward the rear end 64 of the container support deck 44.

The dispenser 12 may include a first stop 72 positioned to engage the container support deck 44 to prevent the front end 62 of the container support deck 44 from pivoting below horizontal. For example, the first stop 72 may protrude from one (or both) of the walls 40, 42 of the dispenser 12, and may be positioned below the container support deck 44 between the pivot point 70 and the front end 50 of the dispenser 12.

Referring to FIG. 5, in the angled configuration, the longitudinal axis D of the container support deck 44 may be disposed at a non-zero angle relative to the horizontal axis H of the dispenser 12. For example, in the angled configuration, the container support deck 44 may be declined from the front end 62 to the rear end 64 (i.e., the front end 62 may be elevated relative to the rear end 64) such that products 16 supported on the container support deck 44 roll down toward the rear end 64 of the container support deck 44 under the force of gravity.

The dispenser 12 may include a second stop 74 positioned to engage the container support deck 44 to prevent the rear end 64 of the container support deck 44 from pivoting below a certain point. For example, the second stop 74 may protrude from one (or both) of the walls 40, 42 of the dispenser 12, and may be positioned below the container support deck 44 between the pivot point 70 and the rear end 54 of the dispenser 12.

Thus, the second stop 74 may fix the maximum decline angle T of the container support deck 44 (i.e., the angle between the horizontal axis H and the declined axis D). In one expression, the maximum decline angle T may be at most 45 degrees. In another expression, the maximum decline angle T may be at most 30 degrees. In another expression, the maximum decline angle T may be at most 20 degrees. In yet another expression, the maximum decline angle T may be at most 15 degrees.

In one optional implementation, the dispenser 12 may be structured such that the container support deck 44 is biased to the angled configuration (FIG. 5) when a container 14 is positioned on the container support deck 44. Bias to the angled configuration may be achieved in various ways. As one example, the pivot point 70 may be positioned such that the distance between the pivot point 70 and the rear end 64 of the container support deck 44 is greater than the distance between the pivot point 70 and the front end 62 of the container support deck 44. As another example, the weight of the container support deck 44 may be increased proximate the rear end 64 of the container support deck 44.

In another optional implementation, the dispenser 12 may include a locking mechanism to lock the container support deck 44 in the angled configuration (FIG. 5). For example, the locking mechanism may include a hook or latch that engages the container support deck 44 and locks the container support deck 44 in the angled configuration when the container support deck 44 is moved to the angled configuration.

The product dispensing system 10 may be assembled by positioning the container 14 onto the container support deck 44 of the dispenser 12 such that the access opening 32 (FIG. 3) of the container 14 is aligned with the dispenser opening 68 (FIG. 4) of the dispenser 12. For example, the container 14 may be longitudinally urged toward the rear end 54 of the dispenser 12 along the container support deck 44 until the access opening 32 is aligned with the dispenser opening 68.

During initial loading of the container 14 onto the container support deck 44 of the dispenser 12, the container support deck 44 may be maintained in the horizontal configuration, as shown in FIG. 6. Therefore, once the access opening 32 is aligned with the dispenser opening 68, the rear-most products 16′ in the container 14 may exit the container 14 and move into the dispenser 12 and, ultimately, to the product display area 60. Since the container 14 is being maintained in a generally horizontal configuration, the remaining products 16 in the container 14 are less likely to move toward the access opening 32 and, as such, are less likely to cause product bridging over the access opening 32.

Once the rear-most products 16′ (e.g., the first 3 or 4 products 16) have exited the container 14, the container support deck 44 may pivot to the angled configuration, as shown in FIG. 2. The user (e.g., stock clerk) loading the container 14 onto the dispenser 12 may move the container support deck 44 to the angled configuration after seeing (or hearing) an initial product 16′ drop through the access opening 32 into the dispenser 12. In the angled configuration, the force of gravity may urge the remaining products 16 in the container 14 toward the access opening 32 and, ultimately, into the dispenser 12.

Accordingly, the disclosed product dispensing system 10 may reduce or eliminate product bridging within the container 14 by initially maintaining the container 14 in a generally horizontal configuration on the dispenser 12. Then, after a certain number of products 16′ have exited the container 14, the container support deck 44 may be moved to the angled configuration to allow gravity to urge the remaining products 16 from the container 14 to the dispenser 12 without bridging.

Although various embodiments of the disclosed product dispenser and system have been shown and described, modifications may occur to those skilled in the art upon reading the specification. The present application includes such modifications and is limited only by the scope of the claims.

What is claimed is:

1. A product dispensing system comprising:
a dispenser having a front end longitudinally opposed from a rear end, said dispenser comprising:
a container support deck extending at least partially between said front end and said rear end, wherein said container support deck is moveable between a first configuration and a second configuration; and
a lower support deck positioned below said container support deck, said lower support deck extending at least partially between said front end and said rear end, and defining a product display area.

2. The product dispensing system of claim 1 wherein said container support deck is generally horizontal in said first configuration.

3. The product dispensing system of claim 1 wherein said lower support deck defines a lower level of said dispenser and said container support deck defines an upper level of said dispenser, and wherein said container support deck further defines an opening between said upper level and said lower level.

4. The product dispensing system of claim 1 wherein said product display area is proximate said front end.

5. The product dispensing system of claim 1 wherein said dispenser further comprises a first side wall laterally opposed from a second side wall.

6. The product dispensing system of claim 5 wherein said container support deck is pivotally connected to at least one of said first and said second side walls.

7. The product dispensing system of claim 1 wherein said container support deck defines a longitudinal axis, and wherein said longitudinal axis is disposed at a non-zero angle relative to horizontal when said container support deck is in said second configuration.

8. The product dispensing system of claim 7 wherein said non-zero angle is at most about 45 degrees.

9. The product dispensing system of claim 7 wherein said non-zero angle is at most about 30 degrees.

10. The product dispensing system of claim 7 wherein said non-zero angle is at most about 20 degrees.

11. The product dispensing system of claim 1 wherein said container support deck comprises a front end and a rear end, and wherein said container support deck pivots about a pivot point positioned between said front end of said container support deck and said rear end of said container support deck.

12. The product dispensing system of claim 1 further comprising a container initially housing a plurality of products.

13. The product dispensing system of claim 12 wherein said container is positioned on said container support deck.

14. The product dispensing system of claim 12 wherein said dispenser further comprises an opening tool arranged to automatically open said container and at least partially dispense said plurality of products from said container to said product display area when said container is moved longitudinally along said container support deck.

15. A product dispensing system comprising:
a dispenser having a front end longitudinally opposed from a rear end, said dispenser comprising:
a first side wall laterally opposed from a second side wall;
a container support deck pivotally connected to at least one of said first and said second side walls and moveable between a first configuration and a second configuration, said container support deck having a front end and a rear end, wherein said front end of said container support deck is generally horizontally aligned with said rear end of said container support deck when said container support deck is in said first configuration, and wherein said front end of said container support deck is elevated relative to said rear end of said container support deck when said container support deck is in said second configuration; and
a lower support deck positioned below said container support deck, said lower support deck extending at least partially between said front end of said dispenser and said rear end of said dispenser, and defining a product display area proximate said front end of said dispenser; and
a container is positioned on said container support deck.

16. A method for dispensing products comprising:
providing a dispenser having a front end longitudinally opposed from a rear end, said dispenser comprising:
a container support deck extending at least partially between said front end and said rear end, wherein said container support deck is moveable between a first configuration and a second configuration; and
a lower support deck positioned below said container support deck, said lower support deck extending at least partially between said front end and said rear end, and defining a product display area;
providing a container initially housing a plurality of products;
forming an access opening in said container, said access opening being sized and shaped to allow said plurality of products to pass therethrough;
positioning said container with said access opening on said container support deck and maintaining said container support deck in said first configuration; and
after at least one product of said plurality of products exits said container through said access opening, moving said container support deck to said second configuration.

17. The method of claim 16 wherein said container support deck is generally horizontal in said first configuration.

18. The method of claim 16 wherein said container support deck defines a longitudinal axis, and wherein said longitudinal axis is disposed at a non-zero angle relative to horizontal when said container support deck is in said second configuration.

19. The method of claim 16 further comprising the step of locking said container support deck in said second configuration.

20. The method of claim 16 wherein said moving step is performed after at least three products of said plurality of products exit said container through said access opening.
